(19) United States
(12) Patent Application Publication
(10) Pub. No.: US 2023/0184906 A1
(43) Pub. Date: Jun. 15, 2023

(54) INTEGRATED TX/RX AND SCANNER MODULE

(71) Applicant: BEIJING VOYAGER TECHNOLOGY CO., LTD., Beijing (CN)

(72) Inventors: Anan PAN, Fremont, CA (US); Youmin Wang, Berkeley, CA (US)

(73) Assignee: BEIJING VOYAGER TECHNOLOGY CO., LTD., Beijing (CN)

(21) Appl. No.: 17/549,834

(22) Filed: Dec. 13, 2021

(51) Int. Cl. G01S 7/4863; G01S 17/931; G01S 7/484; G01S 7/481

(52) U.S. Cl. CPC G01S 7/4863; G01S 17/931; G01S 7/484; G01S 7/4817

(57) ABSTRACT

Embodiments of the disclosure provide optical sensing systems, optical sensing methods, and integrated transmitter-receiver-scanner (TX-RX-scanner) modules. An exemplary optical sensing system includes an integrated TX-RX-scanner module and a printed circuit board coupled to the integrated TX-RX-scanner module. The integrated TX-RX-scanner module includes a plurality of optical components optically aligned with each other and a plurality of pins located on edges of the TX-RX-scanner module. The printed circuit board is separated from and connected to the integrated TX-RX-scanner module, and includes one or more serving electronic components connected to the optical components through the plurality of pins located on the edges of the integrated TX-RX-scanner module.

### TECHNICAL FIELD

The present disclosure relates to a light detection and ranging (LiDAR) system, and more particularly to, an integrated transmitter-receiver-scanner module in a LiDAR system.

### BACKGROUND

In a typical coaxial LiDAR system, a laser signal (pulsed or continuous wave) is delivered through transmitting optics (hereinafter referred to as “TX”). After hitting an object in the environment, the laser signal is bounced back (becoming a reflected laser signal) and re-directed onto a detection arm (hereinafter referred to as “RX”), typically via a beam splitter. Next, the reflected laser signal is collected by a photodetector of the detection arm. In practical applications, it is desirable to have a LiDAR system with a smaller size. Current LiDAR systems generally have a size of about 14 cm×14 cm×10 cm, which is still large. To reduce the size of a LiDAR system without affecting the alignment and integration of different components in the system becomes quite challenging in existing LiDAR systems. In the existing LIDAR systems, different components are sitting separately in position, and many of these components (e.g., laser source, detector, scanner) require individual packaging, which makes these components difficult to align accurately and efficiently due to the size, weight, and complexity of each component. Considering that the sizes of the laser source and the photodetector are often on the order of a few tens of micrometers to a few hundreds of micrometers, it is very challenging to achieve, at the component level, high-accuracy mechanical alignment, which itself is crucial to the overall performance and cost for the manufacturing of these LiDAR systems. In addition, due to the individual placements of the TX, RX, and scanner modules, it is difficult to further reduce the overall size of existing LiDAR systems without affecting the complexity of alignment of different components within these LiDAR systems.

Embodiments of the disclosure address the above problems by integrating optical components of a LiDAR system in a single package, to form an integrated TX-RX-scanner module.

### SUMMARY

In one example, embodiments of the disclosure provide an optical sensing system. The optical sensing system may include an integrated transmitter-receiver-scanner (TX-RX-scanner) module comprising a plurality of optical components optically aligned with each other and a plurality of pins located on edges of the TX-RX-scanner module. The optical sensing system further includes a printed circuit board separated from and connected to the integrated TX-RX-scanner module, where the printed circuit board includes one or more serving electronic components connected to the optical components through the plurality of pins located on the edges of the integrated TX-RX-scanner module.

In another example, embodiments of the disclosure provide an integrated TX-RX-scanner module. The integrated TX-RX-scanner module includes a plurality of optical components optically aligned with each other. The integrated TX-RX-scanner module further includes a plurality of pins located on edges of the TX-RX-scanner module, where the plurality of pins are connected to one or more of the optical components on one end, and are connectable, one the other end, to one or more serving electronic components outside the integrated TX-RX-scanner module, or to one or more monitoring devices for aligning the optical components included in the integrated TX-RX-scanner module.

In a further example, embodiments of the disclosure provide a method for forming an optical sensing system. The method includes assembling an integrated TX-RX-scanner module, where the integrated TX-RX-scanner module includes a plurality of optical components optically aligned with each other and a plurality of pins located on edges of the TX-RX-scanner module. The method further includes assembling a printed circuit board coupled to the integrated TX-RX-scanner module, where the printed circuit board includes one or more serving electronic components connectable to the optical components through the plurality of pins located on the edges of the integrated TX-RX-scanner module. The method additionally includes connecting the one or more serving electronic components with the integrated TX-RX-scanner module through the plurality of pins disposed on the edges of the integrated TX-RX-scanner module, to form the optical sensing system containing the integrated TX-RX-scanner module.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system containing an integrated TX-RX-scanner module, according to embodiments of the disclosure.

FIG. 2 illustrates a block diagram of an exemplary LiDAR system containing an integrated TX-RX-scanner module, according to embodiments of the disclosure.

FIG. 3 illustrate a simulation diagram of an exemplary integrated TX-RX-scanner module, according to embodiments of the disclosure.

FIG. 4 illustrates a schematic diagram of an exemplary integrated TX-RX-scanner module, according to embodiments of the disclosure.

FIG. 5 illustrates a schematic diagram of an exemplary integrated TX-RX-scanner module coupled to a printed circuit board, according to embodiments of the disclosure.

FIG. 6 is a flow chart of an exemplary method for forming a LiDAR system containing a TX-RX-scanner module, according to embodiments of the disclosure.

FIG. 7 is a flow chart of an exemplary optical sensing method performed by a LiDAR system containing an integrated TX-RX-scanner module, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide integration of several LiDAR components in a single package that can be sealed or even hermetically sealed. The integrated LiDAR components may be disposed on a same substrate and sealed inside a same package as a single module. According to one example, this single module excludes most active components that are not required for alignment of components in a LiDAR system that are in the light path of the laser beams. The excluded active components may include certain serving electronic components such as signal processing field programmable gate array (FPGA), printed circuit boards (PCBs) for power electronics, readout circuits, and the like. These components usually do not require alignment and their positioning does not impact the light path. The single module may merely include optical components such as various optics and laser strip, detector array, and MEMS scanner, and the coupled driving circuits such as laser driver, MEMS driver, and detector driver. In addition, certain peripheral input/output (I/O) ports may be also integrated into the module. These I/O ports may be configured for setting up connection/communication of certain optical components (such as laser strip, detector array, and MEMS scanner) with other serving electronic components, such as FPGA, readout circuit, and power electronic PCBs, located outside the module. Accordingly, the module may be kept to a compact size (e.g., around 10 cm×6 cm, which is much smaller than other existing LiDAR systems) by keeping the included components at a low profile. Due to the exclusion of certain non-essential active components and the complexity brought by these components, the alignment process required for aligning the optical components included in the module may be simplified.

Other advantages of the disclosed LiDAR system include that the integrated TX-RX-scanner module eliminates the need for individually packaging each key sensitive device, such as the laser and detector dies. In addition, alignment accuracy within a single package can be improved due to pre-alignment as well as the close distance among relevant components inside a same package (e.g., all the elements in the TX-RX-scanner module may be packed together in a package). Furthermore, the disclosed TX-RX-scanner module may be hermetically sealed, and thus the environmental changes such as humidity change that normally cause optics contamination can be prevented. The features and advantages described herein are exemplary and not all-inclusive.

The disclosed LiDAR system with an integrated TX-RX-scanner module can be used in many applications. For example, the disclosed LiDAR system can be used in advanced navigation technologies, such as to aid autonomous driving or to generate high-definition maps, in which the disclosed LiDAR system can be used as an optical sensing system equipped on a vehicle.

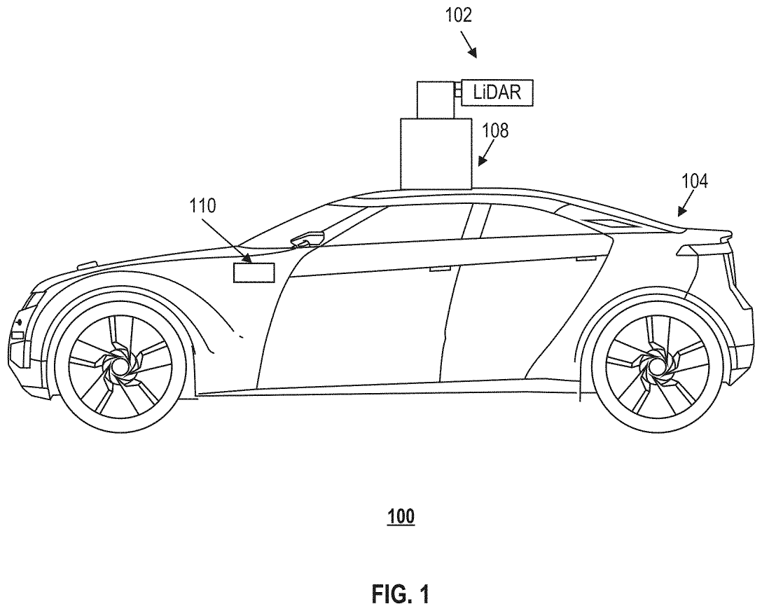

FIG. 1 illustrates a schematic diagram of an exemplary vehicle equipped with an optical sensing system containing an integrated TX-RX-scanner module, according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with an optical sensing system (e.g., a LiDAR system) 102 (also referred to as “LiDAR system 102” hereinafter) mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with laser beams and measuring the reflected/scattered laser signals with a receiver. The laser beams used for LiDAR system 102 may be ultraviolet, visible, or near-infrared, and may be pulsed or continuous wave laser beams. In some embodiments of the present disclosure, LiDAR system 102 may capture point clouds including depth information of the objects in the surrounding environment, which may be used for constructing a high-definition map or 3-D buildings and city modeling. As vehicle 100 moves along the trajectory, LiDAR system 102 may continuously capture data including the depth information of the surrounding objects (such as moving vehicles, buildings, road signs, pedestrians, etc.) for map, building, or city modeling construction.

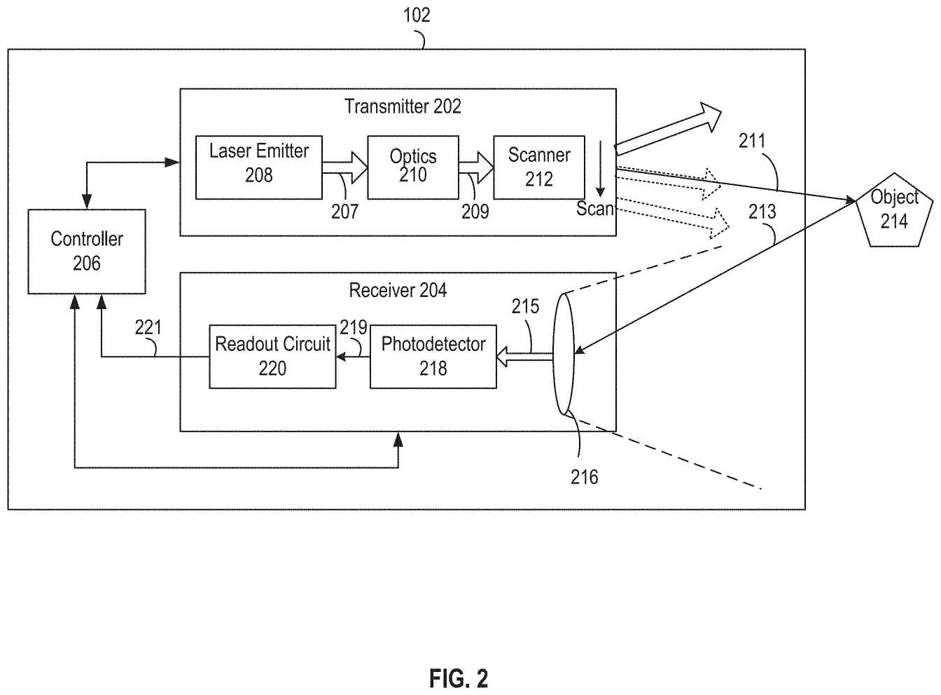

FIG. 2 illustrates a block diagram of an exemplary LiDAR system containing an integrated TX-RX-scanner module, according to embodiments of the disclosure. In some embodiments, LiDAR system 102 may be a biaxial LiDAR, a semi-coaxial LiDAR, a coaxial LiDAR, a scanning flash LiDAR, etc. As illustrated, LiDAR system 102 may include a transmitter 202, a receiver 204, and a controller 206 coupled to transmitter 202 and receiver 204. Transmitter 202 may further include a laser emitter 208 for emitting a laser beam 207, and one or more optics 210 for collimating laser beam 207 emitted by laser emitter 208. In some embodiments, transmitter 202 may additionally include a scanner 212 for steering the collimated laser beam 209 according to a certain pattern. Transmitter 202 may emit optical beams (e.g., pulsed laser beams, continuous wave (CW) beams, frequency modulated continuous wave (FMCW) beams) along multiple directions. Receiver 204 may further include a receiving lens 216, a photodetector 218, and a readout circuit 220. Although not shown, in some embodiments, LiDAR system 102 may further include other optical components. For instance, LiDAR system 102 may additionally include a beam splitter for separating returned laser beams from laser beams emitted by laser emitter 208 in a coaxial LiDAR system.

Laser emitter 208 may be configured to provide laser beams 207 (also referred to as “native laser beams”) to optics 210. For instance, laser emitter 208 may generate laser beams in the ultraviolet, visible, or near-infrared wavelength range, and provide the generated laser beams to optics 210. In some embodiments of the disclosure, depending on underlying laser technology used for generating laser beams, laser emitter 208 may include one or more of a double heterostructure (DH) laser emitter, a quantum well laser emitter, a quantum cascade laser emitter, an interband cascade (ICL) laser emitter, a separate confinement heterostructure (SCH) laser emitter, a distributed Bragg reflector (DBR) laser emitter, a distributed feedback (DFB) laser emitter, a vertical-cavity surface-emitting laser (VCSEL) emitter, a vertical-external-cavity surface-emitting laser (VECSEL) emitter, an extern-cavity diode laser emitter, etc., or any combination thereof. Depending on the number of laser emitting units in a package, laser emitter 208 may include a single emitter containing a single light-emitting unit, a multi-emitter unit containing multiple single emitters packaged in a single chip, an emitter array or laser diode bar containing multiple (e.g., 10, 20, 30, 40, 50, etc.) single emitters in a single substrate, an emitter stack containing multiple laser diode bars or emitter arrays vertically and/or horizontally built up in a single package, etc., or any combination thereof. Depending on the operating time, laser emitter 208 may include one or more of a pulsed laser diode (PLD), a CW laser diode, a Quasi-CW laser diode, etc., or any combination thereof. Depending on the semiconductor materials of diodes in laser emitter 208, the wavelength of emitted laser beams 207 may be at different values, such as 760 nm, 785 nm, 708 nm, 848 nm, 870 nm, 905 nm, 940 nm, 980 nm, 1064 nm, 1083 nm, 1310 nm, 1370 nm, 1480 nm, 1512 nm, 1550 nm, 1625 nm, 1654 nm, 1877 nm, 1940 nm, 2000 nm, etc. It is understood that any suitable laser source may be used as laser emitter 208 for emitting laser beams 207 at a proper wavelength.

Optics 210 may include one or more optics that are configured to shape a laser beam, for example, to collimate a laser beam into a narrow laser beam 209 to increase the scanning resolution and the range to scan object(s) 214. Scanner 212 may include various optical elements such as prisms, mirrors, gratings, optical phased array (e.g., liquid crystal-controlled grating), or any combination thereof. In some embodiments, object(s) 214 may be made of a wide range of materials including, for example, non-metallic objects, rocks, rain, chemical compounds, aerosols, clouds, and even single molecules. In some embodiments, at each time point during a scanning process, scanner 212 may direct laser beams 211 to object 214 in a direction within a range of scanning angles by rotating a deflector, such as a micromachined mirror assembly.

Receiver 204 may be configured to detect laser beams 213 returned from object 214. Upon contact, laser light 211 emitted by transmitter 202 can be reflected/scattered by object 214 via backscattering. Returned laser beams 213 may be in a same or different direction from laser beams 211. In some embodiments, receiver 204 may collect laser beams returned from object 214 and output signals reflecting the intensity of the returned laser beams.

As illustrated in FIG. 2, receiver 204 may include a receiving lens 216, a photodetector 218, and a readout circuit 220. Receiving lens 216 may be configured to collect light from a respective direction in a receiver field-of-view (FOV) and converge the returned laser beams 213 to focus on photodetector 218. At each time point during a scanning process, returned laser beams 213 may be collected by receiving lens 216. Laser beams 213 may be returned from object(s) 214. The pulses in returned laser beam 213 may have the same waveform (e.g., bandwidth and wavelength) as those in laser beams 211.

Photodetector 218 may be configured to detect laser beams 213 returned from object 214 and converged by receiving lens 216. In some embodiments, photodetector 218 may convert the laser light (e.g., laser beams 215) converged by receiving lens 216 into an electrical signal 219 (e.g., a current or a voltage signal). Electrical signal 219 may be an analog signal, which is generated when photons are absorbed in a photodiode included in photodetector 218. In some embodiments, photodetector 218 may include a PIN (p-type, intrinsic, n-type) detector, an avalanche photodiode (APD) detector, a single photon avalanche diode (SPAD) detector, a silicon photo multiplier (SiPM) detector, or the like.

Readout circuit 220 may be configured to integrate, amplify, filter, and/or multiplex signal detected by photodetector 218 and transfer the integrated, amplified, filtered, and/or multiplexed signal onto output parts (e.g., controller 206) for further processing. In some embodiments, readout circuit 220 may act as an interface between photodetector 218 and the signal processing unit (e.g., controller 206). Depending on the configurations, readout circuit 220 may include one or more of a transimpedance amplifier (TIA), an analog-to-digital converter (ADC), a time-to-digital converter (TDC), and the like.

Controller 206 may be configured to control transmitter 202 and/or receiver 204 to perform detection/sensing operations. For instance, controller 206 may control laser emitter 208 to emit laser beams 207, or control photodetector 218 to detect optical signals returned from the environment. In some embodiments, controller 206 may also be implemented to perform data acquisition and analysis functions. For instance, controller 206 may collect digitalized signal information from readout circuit 220, determine the distance of object(s) 214 from LiDAR system 102 according to the travel time of laser beams, and construct a high-definition map or 3-D buildings and city modeling surrounding LiDAR system 102 based on the distance information of object(s) 214.

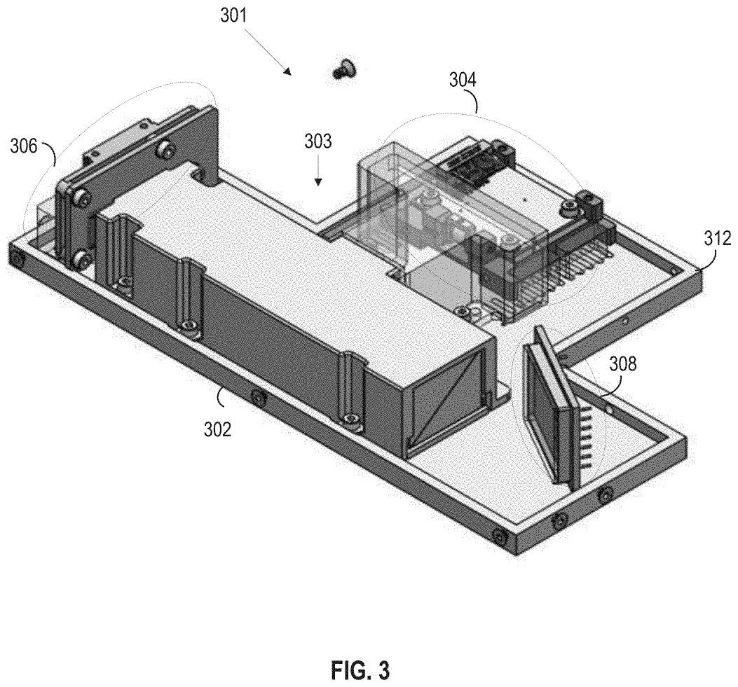

It should be understood that FIG. 2 merely illustrates a block diagram of different functional components within LiDAR system 102. In real applications, these functional components can be organized in different shapes, structures, or configurations. For instance, as previously described and as further described in detail below, to facilitate the alignment process of a LiDAR system and to reduce the overall size of a LiDAR system, certain components may be integrated into a single module and sealed in a single package, but not packaged separately as different transmitter, receiver, and controller modules. For example, optical components that require alignment to form the light path may be integrated into a single package, to form a TX-RX-scanner module, as further described more in detail in FIGS. 3-5.

FIG. 3 illustrates a simulation diagram of an exemplary integrated TX-RX-scanner module, according to embodiments of the disclosure. As illustrated in FIG. 3, an integrated TX-RX-scanner module 301 may include a substrate 302 and certain optical components fixed onto substrate 302. The optical components may include various components that are essential for the alignment of the optical components included in a LiDAR system. For instance, the optical components may include transmitting and receiving components that emit laser beams and receive or detect laser beams returned from the environment. For example, as illustrated in FIG. 3, the optical components may include a laser strip 304 (e.g., a laser diode or a set of laser diodes aligned in a one-dimensional, two-dimensional array, or three-dimensional array) that emits laser beams, and a photodetector 306 (e.g., a photosensor or a set of photosensors aligned in a one-dimensional, two-dimensional, or three-dimensional array) that senses or detects the laser beams returned from the environment during a sensing process by LiDAR system 102. In some embodiments, the optical components may further include a scanner 308 for directing the emitted laser beams towards the environment. Although not shown, the optical components may additionally include certain driving circuits coupled to the optical components, such as a laser driver, receiver driver, and scanner driver, etc.

Although not shown in FIG. 3, the integrated TX-RX-scanner module 301 may further include various optics, such as optical lens, prisms, mirrors, or any combination thereof, for collimating, reflecting, diffracting, collecting, converging optical signals during the operation of a LiDAR system. In one example, the optics inside a TX-RX-scanner module 301 may include one or more collimating lens (e.g., fast axis collimator lens, slow axis collimator lens), a beam splitter, a receiving lens, and the like. In some embodiments, these optics may be aligned with the transmitting, receiving, and scanning optical components, such as components 304, 306, and 308, before being fixed onto substrate 302 to form an integrated TX-RX-scanner module 301.

As previously described, to reduce the overall size of TX-RX-scanner module 301 and to simplify the alignment process, certain serving electronic components may be excluded from TX-RX-scanner module 301. For instance, for a LiDAR system 102, except the optical components such as the various optics and the laser strip, laser detector array, and MEMS scanner, the serving electronic components may not be included in the disclosed TX-RX-scanner module 301. These serving electronic components may include FPGA, readout circuits, and power electronic PCBs that can be separated from the optical components and the coupled driving circuits. For instance, for the transmitter of a LiDAR system, besides the laser diode(s) and the coupled driving circuit, other serving electronic components such as the power supply may be excluded from the integrated TX-RX-scanner module 301. Similarly, for the receiver of a LiDAR system, besides photosensors or photosensor array and the coupled detector driver, other serving electronic components such as the readout circuit and the power electronics may be also excluded from the integrated TX-RX-scanner module 301. For the scanning device of a LiDAR system, depending on the configurations (e.g., various one-dimensional or two-dimensional scanning), the components included in TX-RX-scanner module 301 may be different. However, in general, a platform that actuates the motion of a scanning mirror or reflector of the scanner and a driver/driving circuit for driving the motion of the platform may be included in TX-RX-scanner module 301, while other serving electronic components, such as power electronics and controller(s) for providing the instructions to the driver and/or the actuation platform may be excluded from TX-RX-scanner module 301.

In some embodiments, by excluding these serving electronic components from the disclosed TX-RX-scanner module 301, the integrated TX-RX-scanner module 301 can be made compact. This then reduces the overall size of a LiDAR system. In some embodiments, these excluded serving electronic components can be separately packaged, for example, into a single PCB that can also be made compact and/or fit to the shape and structure of the integrated TX-RX-scanner module 301. For instance, the as-formed integrated PCB containing the excluded serving electronic components may be disposed in space (e.g., a corner as indicated by arrow 303 in FIG. 3) surrounding TX-RX-scanner module 301.

In some embodiments, the excluded serving electronic components may be connected with the optical components and/or coupled drivers through certain pins located on the edges of TX-RX-scanner module 301. For instance, there may be a certain number of pins for each of the optical components 304, 306, and 308 located on the edges of TX-RX-scanner module 301.

In some embodiments, there may be additional pins for certain optics included in the integrated TX-RX-scanner module 301. For instance, certain controllable and/or adjustable optical lenses (e.g., Alvarez lens for adjusting the divergence of emitted laser beams) may be included in TX-RX-scanner module 301. These controllable and/or adjustable optical lenses may also have corresponding pins located on the edge(s) of TX-RX-scanner module 301 for setting up signal communication with the serving electronic components (e.g., controllers for controlling the adjustable optical components).

By including these pins on the edges of the integrated TX-RX-scanner module 301, an already aligned and packaged TX-RX-scanner module 301 may be made functional by just connecting the pins with the respective serving electronic components outside the package, without further moving or adjusting any component inside the package of the integrated TX-RX-scanner module 301 after packaging. This then allows the integrated TX-RX-scanner module 301 to be manufactured and shipped to customers/suppliers as a stand-alone package without the serving electronic components, thereby facilitating the mass production of the integrated TX-RX-scanner modules.

In some embodiments, before fixing the optical components included in the integrated TX-RX-scanner module 301, various alignments may be performed first, as previously described. In one example, fast axis collimator lens and slow axis collimator lens may be aligned with the laser strip, scanning mirror or reflector may be aligned with the laser strip and/or the fast axis collimator lens and slow axis collimator lens, the beam splitter may be aligned with the scanning mirror to reflect returning laser beams to the receiver, collecting lens may be aligned with the beam splitter and/or photosensor(s) in the receiver, and so on. These different alignments may be performed independently according to a predefined order, to ensure the full alignment of the various elements included in the TX-RX-scanner module.

In some embodiments, a large number of TX-RX-scanner modules 301 may be aligned under a uniform alignment setting. For instance, the setting may include one or more monitoring devices that can be connected to the optical components (e.g., through connecting to the pins located on the edges of TX-RX-scanner modules 301), to drive the optical components. According to one embodiment, the setting may include certain power supplies for powering the optical components and certain controllers for controlling the operation of these optical components. In some embodiments, other devices facilitating the alignment processes may be also included in the setting. For instance, certain camera(s) or sensor(s) for signal detection and certain reference retroflector(s) for directing the optical signals may be included in the setting to facilitate the various alignment processes.

In some embodiments, by preparing such an alignment setting, a plurality of TX-RX-scanner modules 301 may be aligned by using the same setting, thereby facilitating the mass production of TX-RX-scanner modules 301 and reducing the alignment cost required for a LiDAR system. To allow each TX-RX-scanner module to align, each TX-RX-scanner module may be connected to the monitoring devices through a subset of pins located on the edges of the TX-RX-scanner module. That is, instead of connecting to each respective serving electronic component of a LiDAR system for alignment, a disclosed TX-RX-scanner module may be aligned without the presence of such serving electronic components in an actual LiDAR system. This then simplifies the alignment process, thereby reducing the alignment cost and facilitating the mass production of disclosed TX-RX-scanner modules.

After the alignment, the optical components may be fixed onto a same substrate 302. In some embodiments, to prevent alignment drifting (e.g., the position and/or orientation change of aligned components after the alignment), quick and efficient fixing mechanisms (e.g., fluid dispensing) may be applied, so that the optical components can be fixed onto substrate 302 in a short period of time after the alignment.

In some embodiments, to prevent alignment from drifting due to environmental change after fixing to substrate 302, certain low-thermal-expansion materials may be used for the construction of substrate 302. These low-thermal expansion materials may include certain fine ceramics, such as silicon nitride, aluminum nitride, aluminum oxide, silicon carbide, etc. The low-thermal expansion materials may display little dimension change with changes in temperature, and thus, if used in substrate 302, may greatly reduce system-level alignment drift caused by thermal expansion. In some embodiments, other types of materials/structures may also be used in constructing substrate 302. For instance, a certain type of PCB may be also used to construct substrate 302 that supports the optical components and holds these components together.

In some embodiments, after fixing the optical components, TX-RX-scanner module 301 may be hermetically sealed. By sealing TX-RX-scanner module 301 hermetically, environment changes such as humidity change that normally cause optics contamination can be prevented. In some embodiments, hermetical sealing of integrated TX-RX-scanner module 301 may include the formation of an airtight package that prevents the passage of gases between the inside and outside of the package. In some embodiments, hermetically sealing of integrated TX-RX-scanner module 301 may include removal or exchange of air (e.g., with nitrogen) inside the package of integrated TX-RX-scanner module 301.

In some embodiments, to allow laser beams to be directed towards the environment outside the package, the hermetically sealed package of integrated TX-RX-scanner module 301 may include a glass window for light passage. That is, emitted laser beams may pass through such a glass window of the hermetically sealed package, to reach object(s) in the surrounding of a LiDAR system. In some embodiments, when returned laser beams are in a different direction from emitted laser beams (e.g., in a biaxial LiDAR system), an optical filter may be used in lieu of glass in the glass window, to help filter out any ambient light that has a wavelength different than the laser wavelength. This helps reduce ambient light noise and thus improves the performance of a LiDAR system.

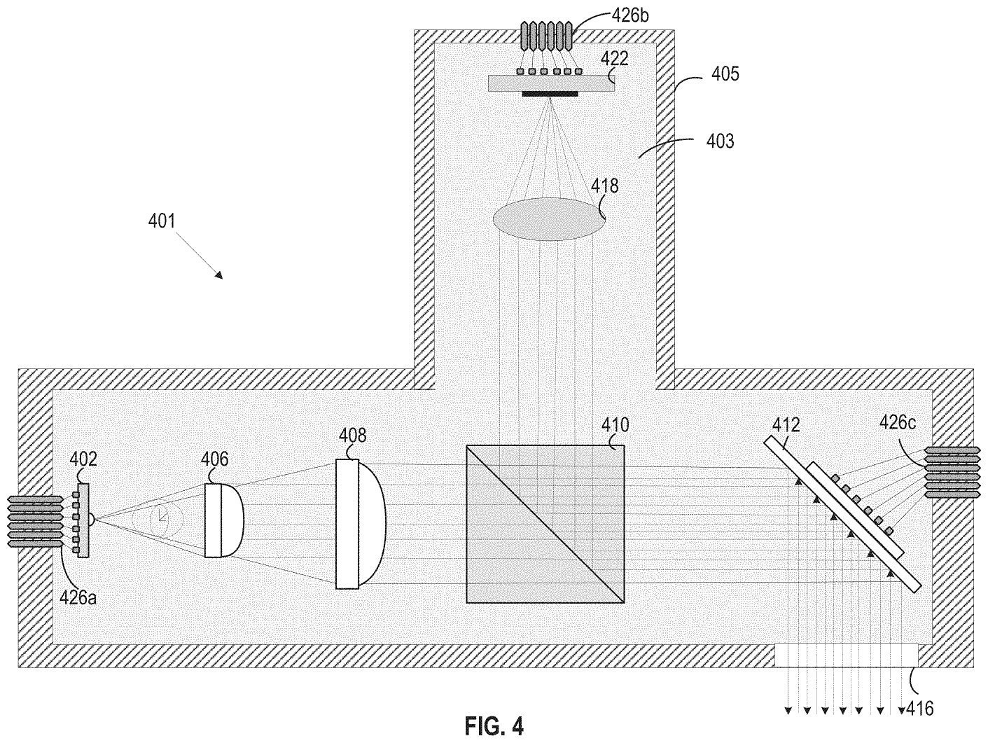

It is to be noted, the above-described components inside a TX-RX-scanner module 301 are merely for illustrative purposes, and not for limitation. In some embodiments, a TX-RX-scanner module 301 may include more or fewer components than those described above. For instance, a TX-RX-scanner module 301 may additionally include certain sensors for facilitating the operation of the disclosed TX-RX-scanner module in a LiDAR system. In one example, a thermometer for monitoring the environmental change may be included in a TX-RX-scanner module, to prevent overheat of the disclosed TX-RX-scanner module in a LiDAR system. Additional information (e.g., pins and bonding wires) about the disclosed TX-RX-scanner module are further described in detail in FIG. 4.

FIG. 4 illustrates a schematic diagram of an exemplary TX-RX-scanner module 401, according to embodiments of the disclosure. As illustrated, the disclosed TX-RX-scanner module 401 may include a substrate 403 for hosting optical components inside a package 405. On the sidewall of package 405, there are multiple sets of pins that are connected to the optical components inside package 405. For instance, there is one set of pins 426a connecting to a laser strip 402, another set of pins 426b connecting to a photosensor or photosensor array 422, and a third set of pins 426c connecting to a MEMS-driven scanning mirror or reflector 412. These pins may be connected to the respective optical components and/or their drivers through one or more bonding wires set up for signal transmission.

Inside package 405, different optical components may be disposed in a pattern following the general organization of components inside a LiDAR system. For instance, as shown in FIG. 4, laser strip 402 may be disposed on one end of package 405, while a scanning mirror or reflector 412 is disposed on another end of package 405. Along the light path from laser strip 402 to the scanning mirror or reflector 412, a set of collimator lenses (e.g., a fast axis collimator lens 406 and a slow axis collimator lens 408) may be sequentially disposed, which are followed by a beam splitter 410. On a third end of package 405, a photosensor or photosensor array 422 may be disposed. Right before photosensor (or photosensor array) 422 along the light path, a receiving lens 418 may be disposed, which is configured to focus the returning laser beams onto photosensor or photosensor array 422. In some embodiments, a window 416 may be further arranged on a sidewall of TX-RX-scanner module 401, for example, on one sidewall of package 405. Window 416 may allow laser beams to pass through package 405. In some embodiments, package 405 itself may be a non-transparent package (except window 416) configured to limit the ambient light.

As previously described, the different optical components or optics (e.g., 406, 408, 410, and 418) may be pre-aligned before fixing to substrate 403. For instance, fast axis collimator lens 406 and slow axis collimator lens 408 may be pre-aligned with laser strip 402. Receiving lens 418 may be pre-aligned with photosensor (or photosensor array) 422. Beam splitter 410 may be pre-aligned with laser strip 402, scanning mirror or reflector 412, and photosensor (or photosensor array) 422. Scanning mirror or reflector 412 may be also aligned with fast axis collimator lens 406 and slow axis collimator lens 408. Other alignments are also possible. In some embodiments, active alignment technology may be employed in the alignment of these different optical components inside package 405.

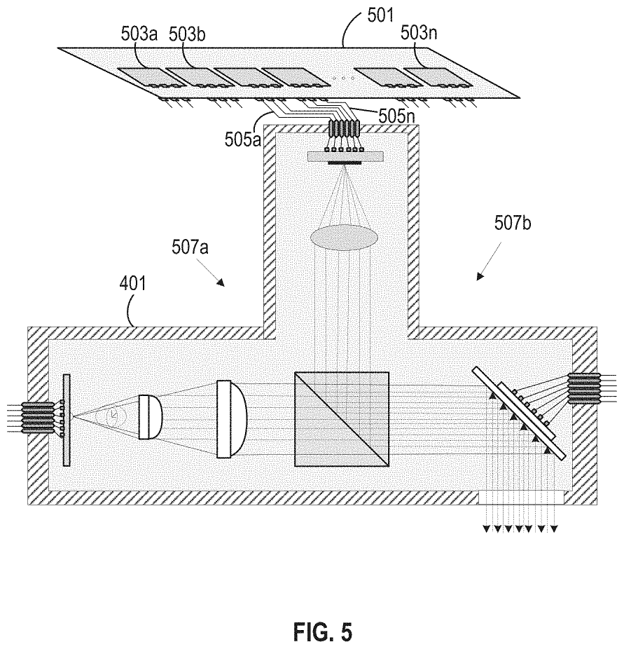

It is to be noted that the disclosed TX-RX-scanner module 401 is merely for illustrative purposes, and not for limitation. In some embodiments, a TX-RX-scanner module 401 may include more or fewer components than those illustrated in FIG. 4. For instance, depending on the configuration of a LiDAR system, a TX-RX-scanner module 401 may include a set of Alvarez lenses for tuning emitted laser beams. For another instance, a beam splitter may not be included in a TX-RX-scanner module if a LiDAR system 102 is a biaxial LiDAR system. Additionally, in some embodiments, the optical components 402, 412, and 422 may be connectable to the respective serving electronic components of a LiDAR system through the pins 426a-426c, as further illustrated in detail in FIG. 5.

FIG. 5 illustrates a schematic diagram of an exemplary LiDAR system containing a TX-RX-scanner module 401 and a coupled PCB 501, according to embodiments of the disclosure. As illustrated, besides TX-RX-scanner module 401, a LiDAR system may further include a PCB 501 that holds the serving electronic components 503a, 505b, . . . , 503n (together or individually may be referred to as serving electronic component 503) for different optical components inside TX-RX-scanner module 401. These serving electronic components 503 may be integrated into a same PCB board to save the space and/or manufacturing cost. In addition, these serving electronic components may be connectable to the respective optical components (e.g., 402, 412, and 422) illustrated in FIG. 4, and to other controllable and/or adjustable optics, through pins and flexible bonding wires (e.g., bonding wires 505a, . . . , 505n illustrated in FIG. 5). To set up such connections, PCB board 501 may also include certain pins or other types of I/O ports, which then allow a connection between PCB board 501 and the coupled TX-RX-scanner module 401.

In some embodiments, the serving electronic components 503a-503n may include power electronics for each of the optical components (e.g., 402, 412, and 422) and/or for other adjustable or controllable optics. In addition, the serving electronic components may include various FPGA elements. For instance, controller 206 of a LiDAR system 102 may be an FPGA element integrated into PCB 501. For another instance, another controller for controlling the motion of a MEMS scanner in a LiDAR system may be a separate FPGA element, or may be incorporated into the same FPGA element for controller 206 as described above. In some embodiments, certain other serving electronic components, such as readout circuits, that facilitate the operation of a LiDAR system may also be possible and be integrated into PCB 501.

It is to be noted that PCB 501 is not necessarily one single piece, but can include multiple pieces that are disposed in a same or separate places around a TX-RX-scanner module 401. By configuring multiple pieces of PCBs, it may facilitate the distribution of the PCB board(s) around TX-RX-scanner module 401. For instance, two pieces of PCBs may be separately disposed on the left corner and right corner, as indicated by arrows 507a and 507b, which then reduces the overall size of a LiDAR system. In addition, by including multiple pieces of PCB board, each piece may be disposed in a convenient location to allow the included serving electronic components to be close to the corresponding optical components, thereby shortening the bonding wires used for signal transmission. This can improve the signal-to-noise ratio during the signal transmission process due to the shorter wires used for signal transmission.

As can be seen from FIG. 5 and as previously described, since a TX-RX-scanner module can be pre-aligned and mass-produced, a disclosed LiDAR system 102 may be assembled in a way different from other existing LiDAR systems that organize different transmitter, receiver, and scanner as individual modules. That is, instead of assembling the individual transmitter, receiver, scanner, and the relevant optics, the disclosed LiDAR system is formed by assembling an integrated TX-RX-scanner module with a PCB(s) containing remaining serving electronic components. These serving electronic components may include certain components that are generally considered part of the transmitter, receiver, and scanner in other existing LiDAR systems, such as power electronics for each transmitter, receiver, and scanner, etc. However, in the disclosed embodiments, these serving electronic components are separate from the respective optical components in the LiDAR system, to simplify the alignment process/cost and reduce the overall size of the disclosed LiDAR system.

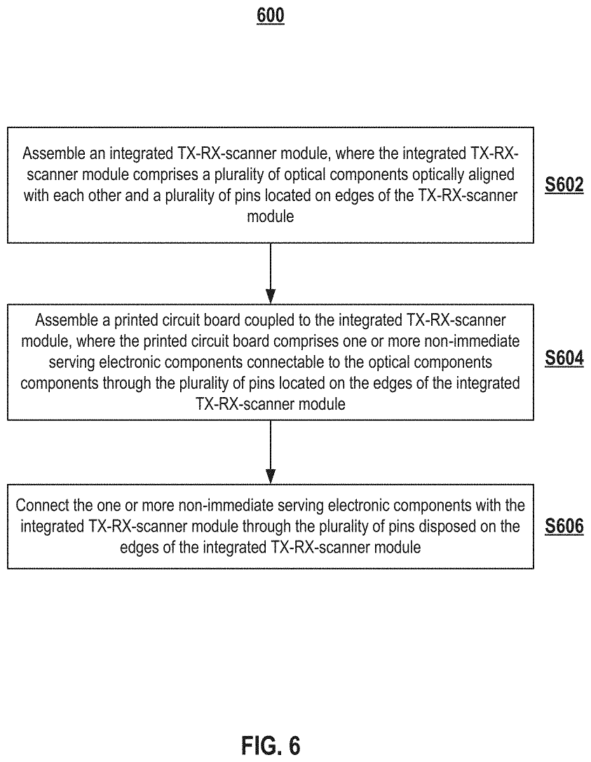

FIG. 6 illustrates a flow chart of an exemplary method 600 for forming a LiDAR system containing a TX-RX-scanner module, according to embodiments of the disclosure. In some embodiments, method 600 may include steps S602-S606. It is to be appreciated that some of the steps may be optional. Further, some of the steps may be performed simultaneously, or in a different order than that shown in FIG. 6.

In step S602, an integrated TX-RX-scanner module is generated, where the integrated TX-RX-scanner module may include a plurality of optical components. For instance, as described in FIGS. 4-5, multiple optical components, such as laser strip, photosensor array, MEMS scanner, including the corresponding drivers, may be included inside an integrated TX-RX-scanner module. In addition, various other optics, such as collimator lens, receiving lens, and beam splitter, may be also included in the formed TX-RX-scanner module. These optical components may be pre-aligned with each other and then fixed onto a same substrate inside the TX-RX-scanner module. The TX-RX-scanner module may be then sealed (e.g., hermetically sealed) inside a chamber as a package.

As also described in FIGS. 4-5, on the edges (e.g., on the sidewalls) of the TX-RX-scanner module, multiple pins may be included to set up a connection between the TX-RX-scanner module and other serving electronic components supporting the functions of the optical components inside the TX-RX-scanner module. These pins may run across the sidewalls of the TX-RX-scanner module and may be pre-connected to the respective optical components inside the TX-RX-scanner module (e.g., through bonding wires) before the package of the TX-RX-scanner module is hermetically sealed.

In step S604, a PCB board corresponding to the integrated TX-RX-scanner module is generated, where the PCB board includes one or more serving electronic components connectable to the optical components included in the TX-RX-scanner module through the pins located on the edges of the integrated TX-RX-scanner module. The generated PCB board may include various serving electronic components, such as power supplies for each optical component, FPGA for data acquisition and analysis, readout circuit, and FPGA for controlling the optical components. The generated PCB may be in the form of a single piece where the various serving electronic components may be integrated into a single piece. Alternatively, the generated PCB may be in the form of multiple pieces, where different pieces of PCB boards may include respective serving electronic components. In some embodiments, the generated PCB(s) may also include certain I/O ports, such as pins, for establishing communication with the respective optical components in the integrated TX-RX-scanner module.

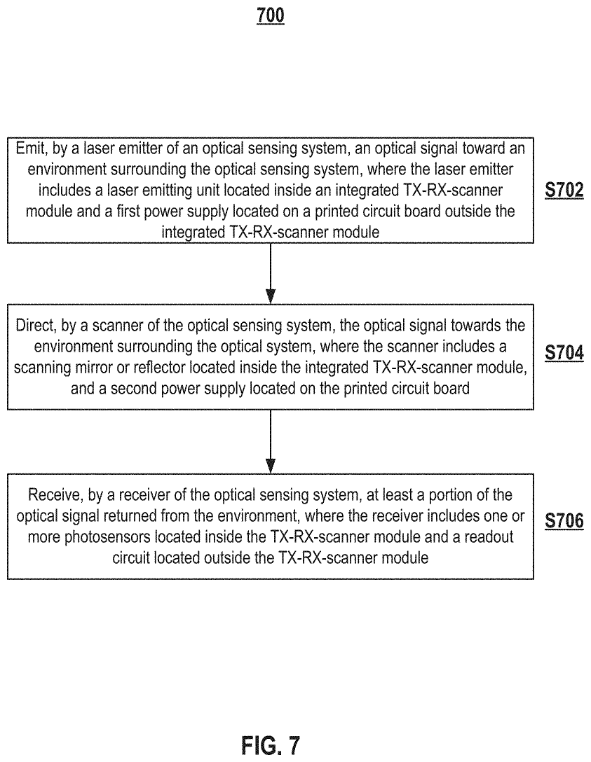

In step S606, the one or more serving electronic components inside the generated PCB(s) are connected with the optical components in the integrated TX-RX-scanner module through the plurality of pins disposed on the edges of the integrated TX-RX-scanner module, to form a LiDAR system containing an integrated TX-RX-scanner module. The as-formed LiDAR system may have a much smaller size than other existing LiDAR systems, which may greatly reduce the overall LiDAR module cost, ease overall integration in the formation of a LiDAR system, and add module compatibility on a vehicle, thereby facilitating the use of a LiDAR system in practical applications. One of such applications is described below in FIG. 7.

FIG. 7 is a flow chart of an exemplary optical sensing method 700 performed by a LiDAR system containing an integrated TX-RX-scanner module, according to embodiments of the present disclosure. In some embodiments, method 700 may be performed by various components of a disclosed LiDAR system 102, e.g., by various components included in an integrated TX-RX-scanner module and a coupled PCB board. In some embodiments, method 700 may include steps S702-S706. It is to be appreciated that some of the steps may be optional. Further, some of the steps may be performed simultaneously, or in a different order than that shown in FIG. 7.

In step S702, a laser emitter of an optical sensing system (e.g., laser strip 402 of integrated TX-RX-scanner module 401 of LiDAR system 102) may emit an optical signal toward one or more optics (e.g., fast axis collimator lens 406 and slow axis collimator lens 408) of the optical sensing system. As previously described, the one or more optics (e.g., 406 and 408) and the laser strip 402 may be disposed on a same substrate inside a hermetically sealed package 405 of integrated TX-RX-scanner module 401. The one or more optics (e.g., 406 and 408) may be aligned with laser strip 402 before being hermetically sealed in the package. The laser strip 402 may be connected to a power supply located outside (e.g., on a PCB) the integrated TX-RX-scanner module 401. The power supply may provide the power to laser strip 402 when emitting an optical signal. In some embodiments, the one or more optics (e.g., 406 and 408) may form the optical signal received from the laser strip into a predefined shape (e.g., a narrow laser beam).

In step S704, a scanner of the optical sensing system may direct the optical signal having the predefined shape to an environment surrounding the optical sensing system. The shaped optical signal may be directed to the environment outside the package of integrated TX-RX-scanner module 401, e.g., through a glass window on the sidewall of the package. The environment may include one or more objects, which may reflect the optical signal back to integrated TX-RX-scanner module 401 of LiDAR system 102.

As previously described, the scanner of the optical sensing system may include two separate parts to implement different functions. For instance, the scanner may include a scanning mirror or reflector that reflects the shaped optical signal, and a platform (e.g., a MEMS-based platform) that drives the motion of the scanning mirror or reflector. Both the scanning mirror or reflector part and the platform part are packaged inside the integrated TX-RX-scanner module. On the other hand, the controller(s) for providing the instructions to the platform (e.g., in the form of FPGA) and the power electronics for powering the motion of the platform may be excluded from the integrated TX-RX-scanner module, but are included inside a PCB outside the TX-RX-scanner module. The controller may send the instructions from the FPGA inside the PCB to the driving platform through the pins on the edges of the integrated TX-RX-scanner module, which then drive the scanning mirror or reflector to direct the shaped optical signal towards the environment according to a predefined pattern.

In step S706, a receiver of the optical sensing system, which includes a photodetector (e.g., a photosensor or a photosensor array 422) may receive the returned optical signal from the environment. For instance, after passing through the glass window (e.g., glass window 416) of the sealed package of integrated TX-RX-scanner module 401, the returned optical signal may be reflected by one or more reflectors (e.g., beam splitter 410) that guide the returned optical signal to the photosensor array 422 of the receiver frontend. Next, the returned optical signal may pass through a receiving lens (e.g., receiving lens 418), which converges and focuses the returned optical signal on the photosensor(s) of the receiver frontend. The photosensor(s) then senses the returned optical signal and converts the optical signal to an electrical signal reflecting the intensity of the optical signal. Depending on the configuration of the receiver frontend, the electrical signal may be a current or voltage signal. Through bonding wires, the electrical signal may be then transmitted to a serving electronic component (e.g., a readout circuit) outside the package of the integrated TX-RX-scanner module for further processing, e.g., converting the electrical signal to a digital signal. The digitalized signal may be forwarded to another serving electronic component (e.g., in the form of FPGA) of the optical sensing system for further processing, e.g., for data acquisition and analysis, and for constructing a high-definition map or 3-D buildings and city modeling during a navigation process by a vehicle mounted with the optical sensing system containing a disclosed TX-RX-scanner module.

Although the disclosure is made using a LiDAR system as an example, the disclosed embodiments may be adapted and implemented to other types of optical sensing systems that use receivers to receive optical signals, not limited to laser beams. For example, the embodiments may be readily adapted for optical imaging systems or radar detection systems that use electromagnetic waves to scan objects.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It is intended that the specification and examples be considered as exemplary only, with a true scope being indicated by the following claims and their equivalents.

What is claimed is:

1. An optical sensing system, comprising:
an integrated transmitter-receiver-scanner (TX-RX-scanner) module comprising a plurality of optical components that are optically aligned with each other and a plurality of pins located on edges of the integrated TX-RX-scanner module; and
a printed circuit board separated from and connected to the integrated TX-RX-scanner module, the printed circuit board comprising one or more serving electronic components connected to the optical components through the plurality of pins located on the edges of the integrated TX-RX-scanner module.

2. The optical sensing system of claim 1, wherein the optical components comprise one or more laser diodes and one or more photosensors aligned in a one-dimensional or two-dimensional array, and a scanning optical unit in proximity to the one or more laser diodes and the one or more photosensors.

3. The optical sensing system of claim 2, wherein the scanning optical unit is a micro-electro-mechanical systems (MEMS) scanning mirror.

4. The optical sensing system of claim 1, wherein the optical components comprise one or more of a fast axis collimator, a slow axis collimator, a beam splitter, and a receiving lens.

5. The optical sensing system of claim 1, wherein the integrated TX-RX-scanner module further comprises a plurality of driving circuits coupled to the optical components.

6. The optical sensing system of claim 5, wherein the driving circuits comprise one or more of a laser driver, a receiver driver, and a scanner driver.

7. The optical sensing system of claim 1, wherein the optical components are disposed on a same substrate after optical alignment.

8. The optical sensing system of claim 1, wherein the optical components are assembled inside a same package.

9. The optical sensing system of claim 8, wherein the package of the integrated TX-RX-scanner module is hermetically sealed.

10. The optical sensing system of claim 1, wherein the serving electronic components comprise one or more power supplies, each power supply being coupled to an optical component.

11. The optical sensing system of claim 1, wherein the serving electronic components comprise one or more readout circuits.

12. The optical sensing system of claim 11, wherein the one or more readout circuits comprise one or more of a transimpedance amplifier, an analog-to-digital converter, a time-to-digital converter.

13. The optical sensing system of claim 1, wherein the serving electronic components are connected to the plurality of pins located at the edges of the integrated TX-RX-scanner module through a plurality of flexible bonding wires.

14. An integrated TX-RX-scanner module, comprising:
a plurality of optical components optically aligned with each other; and
a plurality of pins located on edges of the integrated TX-RX-scanner module, wherein the plurality of pins are connected to one or more of the optical components on one end, and are connectable, on the other end, to one or more serving electronic components outside the integrated TX-RX-scanner module, or to one or more monitoring devices for aligning the optical components included in the integrated TX-RX-scanner module.

15. The integrated TX-RX-scanner module according to claim 14, wherein the optical components comprise one or more laser diodes and one or more photosensors aligned in a one-dimensional or two-dimensional array, and a scanning optical unit in proximity to the one or more laser diodes and the one or more photosensors.

16. The integrated TX-RX-scanner module according to claim 14, wherein the optical components comprise one or more of a fast axis collimator, a slow axis collimator, a beam splitter, and a receiving lens.

17. The integrated TX-RX-scanner module according to claim 14, wherein the integrated TX-RX-scanner module further comprises a plurality of driving circuits coupled to the optical components.

18. The integrated TX-RX-scanner module according to claim 14, wherein the optical components included in the integrated TX-RX-scanner module are disposed on a same substrate after optical alignment.

19. The integrated TX-RX-scanner module according to claim 14, wherein the optical components are sealed inside a same package.

20. A method for forming an optical sensing system, comprising:
assembling an integrated TX-RX-scanner module, wherein integrated TX-RX-scanner module comprises a plurality of optical components optically aligned with each other and a plurality of pins located on edges of the integrated TX-RX-scanner module;
assembling a printed circuit board coupled to the integrated TX-RX-scanner module, wherein the printed circuit board comprises one or more serving electronic components connectable to the optical components through the plurality of pins located on the edges of the integrated TX-RX-scanner module; and
connecting the one or more serving electronic components with the integrated TX-RX-scanner module through the plurality of pins disposed on the edges of the integrated TX-RX-scanner module, to form the optical sensing system containing the integrated TX-RX-scanner module.
